(19) United States
(12) Patent Application Publication
(10) Pub. No.: US 2022/0374681 A1
(43) Pub. Date: Nov. 24, 2022

(54) Method for predicting wave energy based on improved GRU

(71) Applicant: Zhihan Lv, Visby (SE)

(72) Inventors: Zhihan Lv, Visby (SE); Ranran Lou, Qingdao (CN); Jinhua Li, Qingdao (CN)

(21) Appl. No.: 17/860,717

(22) Filed: Jul. 8, 2022

(51) Int. Cl. G06N 3/04; G06N 3/08

(52) U.S. Cl. CPC G06N 3/0445; G06N 3/0472; G06N 3/08

(57) ABSTRACT

Method for predicting wave energy based on improved GRU A method for predicting wave energy based on improved GRU includes steps of: 1) determining input features of a prediction model; 2) using a Bayesian optimization algorithm to determine hyperparameters of the prediction model; 3) training the prediction model to obtain wave height and wave period prediction models; 4) using a test set to compare prediction results of the prediction model with observed values, so as to determine whether an optimization end condition of the Bayesian optimization algorithm is reached; and 5) using a wave energy conversion formula to convert predicted values of the wave height and the wave period into a predicted value of wave energy. The present invention improves on the original Gated Recurrent Unit (GRU) network, and proposes a GRU wave energy prediction model based on Bayesian optimization and attention mechanism.

### BACKGROUND OF THE PRESENT INVENTION

### Field of Invention

The present invention relates to a technical field of wave energy prediction, and more particularly to a method for predicting wave energy based on improved GRU.

### Description of Related Arts

Energy is the material basis for the survival and development of human society, and has a particularly important strategic position in the national economy. Nowadays, with the development of economy and society, people's demand for fossil energy such as coal and oil is increasing. This has brought about serious shortages of non-renewable energy and the increasing destruction of the ecological environment.

Carbon dioxide and other greenhouse gas emissions from large-scale energy consumption are one of the main causes of current global climate change. In recent years, more and more countries have made carbon emission reduction an important task in the future. Sweden and Austria have closed all coal-fired power plants and withdrawn from the use of coal power. Germany and Chile plan to phase out coal by 2040. Carbon neutrality refers to the total amount of carbon dioxide or greenhouse gas emissions directly or indirectly generated by a country, enterprise, product, activity or individual within a certain period of time, which is offset through afforestation, energy conservation and emission reduction, and achieves relatively “zero emissions”. Up to now, more than 100 countries in the world have proposed the goal of achieving carbon neutrality. In 2020, the Chinese government proposed at the 75th United Nations General Assembly to strive to achieve carbon neutrality by 2060.

The development of renewable energy to replace traditional fossil energy is fundamental to achieve the goal of carbon neutrality. The ocean, which accounts for 71% of the earth's area, is very rich in resources and has huge development potential. It has numerous biological resources, mineral resources and power resources. According to the report published by the International Energy Organization (IEA), different marine energy technologies can meet the current global electricity demand of nearly 20,000 TWh globally. Among them, the waves provide huge renewable energy.

A device that converts wave energy into electrical energy is called a wave energy converter (WEC). Compared with traditional power generation methods, ocean wave power generation has the following advantages: (1) high energy density, the energy density of ocean waves is the highest among all renewable energy sources (the density is about 1,000 times that of wind); (2) The negative impact of WEC on the environment during use is low; (3) Waves can travel long distances with little energy loss; (4) Higher power generation efficiency. According to data, the power generation rate of wave power generation devices is as high as 90%, while the power generation rate of wind and solar power generation devices is 20%-30%.

The energy of the waves is the most important factor in determining the amount of electricity generated. Accurate wave energy prediction can help people quickly obtain the energy reserves of a specific sea area. Before energy conversion, it can provide a reference for the design and deployment of WEC, so that it can be deployed in the sea area with high energy density as much as possible. After the energy conversion, the working state of the WEC can be adjusted in time according to the offshore environment and electricity demand. Although wave energy shows many advantages over other renewable energy sources, waves are more difficult to characterize and predict due to their randomness. According to existing research, wave energy can be expressed by the formula F=0.49·H²·T, where H is the wave height and T is the wave period. Therefore, accurate prediction of wave height and wave period is an important prerequisite for wave energy power prediction.

In the past, wave parameter prediction mostly relied on numerical models. This method establishes an energy balance equation by simulating the wave evolution process generated by the wind field acting on the ocean surface, so as to achieve relatively satisfactory forecast results. Common data models include Wave Model (WAM) established by WAMDI, Simulating Wave Nearshore (SWAN) developed by Booij, and WAVE WATCH III (WW3) developed by the US National Oceanic and Atmospheric Administration for wave simulation and forecasting. At the same time, the numerical prediction method has the disadvantages of complex implementation, many inputs, and long processing time, which is not conducive to the accurate and rapid prediction of waves.

The integration of ocean observations with artificial intelligence has become a topic of increasing interest to oceanographic researchers. As one of the most important branches of artificial intelligence, machine learning is being applied in more and more fields, such as medicine, economics, agriculture, meteorology, etc. There is a lot of research into wave prediction using machine learning. Deo and Naidu proposed the use of feedforward neural networks to predict wave height as early as 1998. Support vector machines (SVM) are often used for their structural risk minimization (SRM) properties. Gao et al. proposed a method for predicting wave height based on the SVM regression model of the advanced synthetic aperture radar (ASAR) wave pattern data. In this method, the characteristic parameters of the SAR image are the input parameters of the SVM regression model, and the particle swarm optimization algorithm is used to optimize the input kernel parameters of the SVM regression model, and the SVM model is established. Because the neural network has strong learning ability, it can construct nonlinear models with complex relationships, and it is often used for wave prediction in recent years. Kumar et al. predicted diurnal wave height in different geographic regions using minimum resource allocation network (MRAN) and growing and pruning padial basis function (GAP-RBF) network. Mo and Li used a convolutional neural network (CNN) to predict the wave conditions in the Beibu Gulf waters for the next six hours. The long short-term memory (LSTM) network improved from the recurrent neural network (RNN) has a unique chain structure, so it is very suitable for processing time series data such as wave. In 2020, Fan et al. proposed using the LSTM network to predict the 1 hour and 6 hour wave heights of ten sites with different environmental conditions, and compared them with the results of six other algorithms, proving the superiority of LSTM in wave height prediction. Ni and Ma studied a deep learning model combining LSTM with principal component analysis (PCA) to predict wave heights continuously for two and a half months using data from four buoys deployed in two polar westerlies.

Although the current methods for wave parameter prediction emerge in an endless stream, there are few studies on wave energy prediction. Therefore, this study proposes a wave energy prediction model based on the improved GRU. Based on the original GRU network, we added a Bayesian optimization algorithm to optimize the hyperparameters of the model. In addition, we also added an attention mechanism to assign different weights to the features during the training process of the model to achieve a more accurate prediction effect. First, the model is used to predict wave height and wave period. After that, the wave energy conversion formula is used to achieve the purpose of accurate wave energy prediction. In the prediction experiments of 1 hour and 6 hour, the results prove the superiority of the GRU wave energy power prediction model based on Bayesian optimization and attention mechanism.

### SUMMARY OF THE PRESENT INVENTION

An object of the present invention is to provide a GRU wave energy prediction method based on Bayesian optimization and attention mechanism, wherein in the training process, the hyperparameters of the model are optimized by the Bayesian optimization algorithm, and assigns different weights to the features through the attention mechanism to improve the prediction accuracy; and in the prediction process, the model first predicts the wave height and wave period, and then uses the conversion formula between wave height and wave period to achieve accurate prediction of wave energy.

Accordingly, in order to accomplish the above object, the present invention provides a method for predicting wave energy based on improved gated recurrent unit (GRU), comprising steps of:
1) determining input features of a prediction model;
2) using a Bayesian optimization algorithm to determine hyperparameters of the prediction model, wherein in a hidden layer of the prediction model, different weights are assigned to the input features through an attention mechanism;
3) training the prediction model to obtain wave height and wave period prediction models;
4) using a test set to compare prediction results of the prediction model with observed values, so as to determine whether an optimization end condition of the Bayesian optimization algorithm is reached; if yes, using the wave height and wave period prediction models to predict a wave height and a wave period separately; if not, continuing hyperparameter optimization;
5) using a wave energy conversion formula to convert predicted values of the wave height and the wave period into a predicted value of wave energy; and
6) providing a reference for location selection of wave energy power generation devices, so as to improve application and promotion of wave energy.

Preferably, in the step 1), the input features are: historical 1-hour wind speed, historical 1-hour wind direction, historical 1-hour wave height, historical 1-hour wave period, historical 2-hour wind speed, historical 2-hour wind direction, historical 2-hour wave height, and historical 2-hour wave period.

Preferably, in the step 1), the input features are normalized with following formulas:

$$\begin{matrix}{X}^{*} = \frac{X - \overline{X}}{δ} \\ δ = \sqrt{\frac{1}{n} {\sum }_{i = 1}^{n} {( {X}_{i} - \overline{X} )}^{2}}\end{matrix}$$

wherein n is a sample size, X* is a processed data, X is an original data, X̅ is a mean of the original data, and δ is a standard deviation of the original data.

Preferably, in the step 2), a method for determine the hyperparameters of the prediction model comprises steps of:
a) randomly initializing a set of hyperparameter value combinations in a search space, and calculating a value of an objective optimization function; wherein for the search space Xₙ, an optimal solution x_{best}, of Bayesian optimization is expressed by a formula:

x_{best}=argmin_{Xn}ƒ(Xₙ)

wherein ƒ is the objective optimization function;
b) continuing to randomly select a hyperparameter combination, calculating an objective function value, and saving a point if the objective function value thereof is better than a best value obtained in history; and
c) repeating the step b) until a preset number of iterations is reached.

Preferably, in the step 2), a Gaussian process of Bayesian optimization consists of following mean and covariance functions:

ƒ(x)˜gp(μ,k(x,x′))

wherein μ is the mean function and k(x, x′) is the covariance function; for a dataset D={(x₁,ƒ(x₁)),(x₂, ƒ(x₂)), . . . , (xₜ, ƒ(xₜ))}, a Gaussian distribution is expressed as:

$$[ \begin{matrix}f ( {x}_{1} ) \\ f ( {x}_{2} ) \\ ⋮ \\ f ( {x}_{t} )\end{matrix} ] ∼ ℊ p ( μ , [ \begin{matrix}k ( {x}_{1} , {x}_{1} ) & k ( {x}_{1} , {x}_{2} ) & … & k ( {x}_{1} , {x}_{t} ) \\ k ( {x}_{2} , {x}_{1} ) & k ( {x}_{2} , {x}_{2} ) & … & k ( {x}_{2} , {x}_{t} ) \\ ⋮ & ⋮ & ⋮ & ⋮ \\ k ( {x}_{t} , {x}_{1} ) & k ( {x}_{t} , {x}_{2} ) & … & k ( {x}_{t} , {x}_{t} )\end{matrix} ] )$$

for the new sample [symbol] , the Gaussian distribution is expressed as:

$$[ \begin{matrix}{f}_{1 : t} \\ {f}_{t + 1}\end{matrix} ] ∼ ℊ p ( μ , [ \begin{matrix}K & {k}^{T} \\ k & k ( {x}_{t + 1} , {x}_{t + 1} )\end{matrix} ] )$$

$$wherein K = [ \begin{matrix}k ( {x}_{1} , {x}_{1} ) & … & k ( {x}_{1} , {x}_{t} ) \\ ⋮ & ⋱ & ⋮ \\ k ( {x}_{t} , {x}_{1} ) & … & k ( {x}_{t} , {x}_{t} )\end{matrix} ] , and$$

$$k = [ ( ( {x}_{t + 1} , {x}_{1} ) , ( {x}_{t + 1} , {x}_{2} ) … ( {x}_{t + 1} , {x}_{t} ) ) ] ;$$

a posterior probability distribution of [symbol] is expressed as:

P( [symbol] |D, [symbol] )=gp(u( [symbol] ),δ²( [symbol] ))

wherein u( [symbol] )=kK⁻¹ƒ₁₊ₜ, and δ²( [symbol] )=k( [symbol] )−kK⁻¹ k^{T}. Preferably, in the step 2), the different weights are assigned to the input features according to following formulas:

$$\begin{matrix}{a}_{t} = \frac{exp ( {e}_{t} )}{{\sum }_{k = 1}^{t} {e}_{k}} \\ {e}_{t} = {u}_{a} tanh ( {W}_{a} {h}_{t} + {b}_{a} )\end{matrix}$$

wherein hₜ is a state vector of the hidden layer in a neural network at a time t, eₜ, is an attention probability distribution value, aₜ is an attention score, uₐ and Wₐ are attention weight vectors, bₐ is an attention bias vector.

Preferably, in the step 3), a mean square error is used as a loss function:

$$M S E = \frac{1}{n} {\sum }_{i = 1}^{n} {( {y}_{i} - {x}_{i} )}^{2}$$

wherein n is a number of samples, yᵢ is the observed value, and xᵢ is the predicted value.

Preferably, in the step 4), a time interval of the observed values is 1 hour and a precision is 0.1; the observed values are obtained by observations for all time frames of the year.

Preferably, in the step 4), to improve data quality and reduce an impact of missing values on model prediction accuracy, a before and after average value filling method is used to fill missing values in the test set, wherein an average value of an attribute value at a moment before the missing value and an attribute value at a moment after the missing value is taken as a filling value at a missing moment; when multiple consecutive values are missing, an average value of two adjacent non-null values is used to fill in.

With the foregoing steps, the present invention improves on the original Gated Recurrent Unit (GRU) network, and proposes a GRU wave energy prediction model based on Bayesian optimization and attention mechanism. In the training process, the hyperparameters of the model are optimized by the Bayesian optimization algorithm, and assigns different weights to the features through the attention mechanism to improve the prediction accuracy. In the prediction process, the model first predicts the wave height and wave period, and then uses the conversion formula between wave energy, wave height and wave period to achieve accurate prediction of wave energy.

These and other objectives, features, and advantages of the present invention will become apparent from the following detailed description, the accompanying drawings, and the appended claims.

### BRIEF DESCRIPTION OF THE DRAWINGS

FIG. 1 is a structural view of LSTM according to the prior art;

FIG. 2 is a structural view of GRU according to the prior art;

FIG. 3 illustrates difference between random search and grid search according to the prior art;

FIG. 4 is a structural view of a GRU wave energy prediction model based on Bayesian optimization and attention mechanism according to a preferred embodiment of the present invention;

FIG. 5 illustrates geographic distribution of two observation stations according to the preferred embodiment of the present invention;

FIG. 6 shows comparison curves of four algorithms on 1-hour wave height prediction according to the preferred embodiment of the present invention;

FIG. 7 shows comparison curves of predicted and observed values of the four algorithms according to the preferred embodiment of the present invention;

FIG. 8 shows comparison curves of the predicted values and observed values of wave energy of the four algorithms in 1-hour prediction according to the preferred embodiment of the present invention;

FIG. 9 shows comparison curves of the predicted values and observed values of wave heights of the four algorithms in 6-hour prediction according to the preferred embodiment of the present invention;

FIG. 10 shows comparison curves of the predicted and observed values of the 6-hour wave period for the four algorithms according to the preferred embodiment of the present invention; and

FIG. 11 shows comparison curves of the predicted and observed values of the 6-hour wave energy of the four algorithms according to the preferred embodiment of the present invention.

### DETAILED DESCRIPTION OF THE PREFERRED EMBODIMENT

Referring to of the drawings, a method for predicting wave energy based on improved GRU according to a preferred embodiment of the present invention will be further illustrated.

Gated Recurrent Unit Network

The GRU network is improved from RNN. By associating neurons between layers in the network, RNN solves the problem that the front and rear inputs in the traditional neural network are independent of each other. Therefore, RNN has certain advantages in learning the nonlinear characteristics of the sequence, making it more suitable for dealing with time problems. RNN is widely used in natural language processing, time series forecasting and other fields. In 1991, Hochreiter discovered that RNN has a long-term dependence problem, that is, when learning a long sequence, the network will appear gradient disappearance and gradient explosion, and it is impossible to grasp the nonlinear relationship of long time span. In order to solve the long-term dependency problem, improved neural networks based on RNNs continue to emerge, including LSTM and GRU.

LSTM was proposed by Hochreiter and Schmidhuber in 1997. LSTM controls the transmission of information in the network through three gate devices (forget gate, input gate, and output gate). Each gate contains a sigmoid function (a) and a dot product operation. σ outputs a number between 0 and 1, indicating how much information can pass through, 0 means no information is allowed to pass through, 1 means any information is allowed to pass through, and the calculation formula is shown in equation (1). In contrast to the recursive computation established by the RNN for the system state, the three gates establish a self-loop to the internal state of the LSTM unit. The input gate determines the input of the current time step and the update of the internal state of the system state of the previous time step; the forget gate determines the update of the internal state of the previous time step to the internal state of the current time step; the output gate determines the internal state to update the system state. The structure of LSTM is shown in FIG. 1.

$${σ}_{( x )} = \frac{1}{1 + {e}^{- α}} \qquad ( 1 )$$

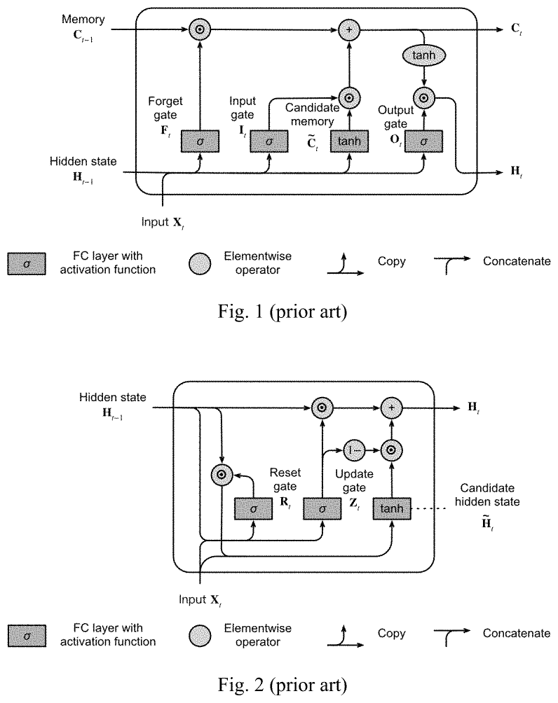

Google's tests show that three gates in an LSTM contribute differently to improving its learning ability, the most important of which is the forgetting gate, followed by the input gate, and finally the output gate. Therefore, omitting the gate with small contribution and its corresponding weight can simplify the neural network structure and improve its learning efficiency. Based on the above concepts, Cho et al. proposed GRU in 2014. Only update gates and reset gates are included in the GRU. The update gate is similar to the forget gate and output gate of LSTM. It is used to control the degree to which the state information of the previous moment is brought into the current state. The larger the value of the update gate, the more the state information of the previous moment is brought in. The reset gate is similar to the input gate of the LSTM, it determines how the new input information is combined with the previous memory, the smaller the reset gate, the less information from the previous state is written. The structure of GRU is shown in FIG. 2. The γₜ in the update gate and the zₜ in the reset gate are obtained by formula (2) and formula (3), respectively. Among them, U and W are weight parameters.

Rₜ=σ(W_{z}Xₜ+Uᵣ [symbol] ) (2)

Zₜ=σ(W_{z}Xₜ+U_{z} [symbol] ) (3)

The current hidden state hₜ is obtained by Equation (4), where the calculation process of the candidate set \tilde{h}ₜ is shown in Equation (5). The tan h is a hyperbolic tangent function whose expression is shown in equation (6).

$${Z}_{t} = σ ( {W}_{z} {x}_{t} + {U}_{z} {h}_{t - 1} ) \qquad ( 3 )$$

$$= tanh ( {W}_{h} {x}_{t} + {U}_{h} ( {r}_{t} ⊙ {h}_{t - 1} ) ) \qquad ( 5 )$$

$$tanh ( x ) = \frac{{e}^{x} - {e}^{- α}}{{e}^{x} + {e}^{- x}} \qquad ( 6 )$$

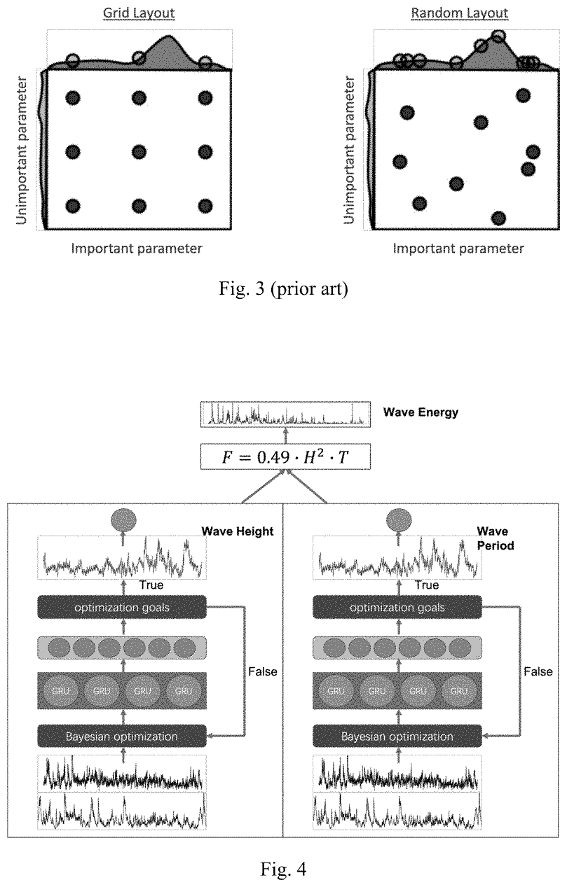

Bayesian Optimization The optimization of the hyperparameters of the model is one of the important factors affecting the final prediction effect. At present, the commonly used hyperparameter optimization methods in research are grid search, random search and Bayesian optimization. According to the given candidate list value of each hyperparameter, grid search tries the effect of each parameter value combination in the test set by traversing, and finally finds the best hyperparameter value combination. Grid search is time-consuming because it needs to iterate through all combinations of candidate hyperparameter values. Random search is similar to grid search, but unlike grid search, which traverses all parameter value combinations, random search randomly selects a fixed number of hyperparameter value combinations within a given parameter value range to find the optimal parameter value or an approximation of the optimal parameter value for the purpose. Random search has a faster search speed, but the resulting hyperparameter values may not be optimal. The difference between random search and grid search is shown in FIG. 3.

The Bayesian parameter tuning method was proposed by Snoek et al. in 2012. Its optimization strategy is to obtain the posterior distribution of the given objective function through the Gaussian process for the parameter value combination selected by sampling. After that, the following parameter value combinations are continuously selected according to the posterior distribution of the previous parameter value combination until the posterior distribution matches the real distribution. For the search space Xₙ, the optimal solution x_{best} of Bayesian optimization can be expressed by formula (7), where ƒ is the objective function. Compared with grid search and random search, the Bayesian optimization method has fewer iterations, faster speed, and more robust performance. And the Bayesian optimization method can continuously update the prior through the Gaussian process, using the historical parameters The combination of values makes decisions about the next choice.

x_{best}=argmin_{Xn}ƒ(Xₙ) (7)

The Gaussian process of Bayesian optimization consists of mean and covariance functions, as shown in Equation (8), where p is the mean and k(x, x′) is the covariance function. For dataset D={(x₁, ƒ(x₁),(x₂,ƒ (x₂), . . . ,(xₜ,ƒ(xₜ))}, the Gaussian distribution is shown in equation (9).

$$\begin{matrix}\begin{matrix}f ( x ) ∼ ℊ p ( μ , k ( x , {x}^{′} ) ) & ( 8 )\end{matrix} \\ \begin{matrix}[ \begin{matrix}f ( {x}_{1} ) \\ f ( {x}_{2} ) \\ ⋮ \\ f ( {x}_{t} )\end{matrix} ] ∼ ℊ p ( μ , [ \begin{matrix}k ( {x}_{1} , {x}_{1} ) & k ( {x}_{1} , {x}_{2} ) & … & k ( {x}_{1} , {x}_{t} ) \\ k ( {x}_{2} , {x}_{1} ) & k ( {x}_{2} , {x}_{2} ) & … & k ( {x}_{2} , {x}_{t} ) \\ ⋮ & ⋮ & ⋮ & ⋮ \\ k ( {x}_{t} , {x}_{1} ) & k ( {x}_{t} , {x}_{2} ) & … & k ( {x}_{t} , {x}_{t} )\end{matrix} ] ) & ( 9 )\end{matrix}\end{matrix}$$

For the new sample [symbol] , the Gaussian distribution is shown in equation (10). The posterior probability distribution of ƒₜ₊₁ is shown in formula (13).

$$\begin{matrix}\begin{matrix}[ \begin{matrix}{f}_{1 : t} \\ {f}_{t + 1}\end{matrix} ] ∼ ℊ p ( μ , [ \begin{matrix}K & {k}^{T} \\ k & k ( {x}_{t + 1} , {x}_{t + 1} )\end{matrix} ] ) & ( 10 )\end{matrix} \\ \begin{matrix}K = [ \begin{matrix}k ( {x}_{1} , {x}_{1} ) & … & k ( {x}_{1} , {x}_{t} ) \\ ⋮ & ⋱ & ⋮ \\ k ( {x}_{t} , {x}_{1} ) & … & k ( {x}_{t} , {x}_{t} )\end{matrix} ] & ( 11 )\end{matrix} \\ \begin{matrix}k = [ ( ( {x}_{t + 1} , {x}_{1} ) , ( {x}_{t + 1} , {x}_{2} ) … ( {x}_{t + 1} , {x}_{t} ) ) ] & ( 12 )\end{matrix} \\ \begin{matrix}P ( {f}_{t + 1} \vert D , {x}_{t + 1} ) = ℊ p ( u ( {x}_{t + 1} ) , {δ}^{2} ( {x}_{t + 1} ) ) & ( 13 )\end{matrix} \\ \begin{matrix}u ( {x}_{t + 1} ) = {kK}^{- 1} {f}_{1 : t} & ( 14 )\end{matrix} \\ \begin{matrix}{δ}^{2} ( {x}_{t + 1} ) = k ( {x}_{t + 1} , {x}_{t + 1} ) - {kK}^{- 1} {k}^{T} & ( 15 )\end{matrix}\end{matrix}$$

The process of Bayesian optimization is as follows.
a) randomly initializing a set of hyperparameter value combinations in a search space, and calculating a value of an objective optimization function; b) continuing to randomly select a hyperparameter combination, calculating an objective function value, and saving a point if the objective function value thereof is better than a best value obtained in history; and
c) repeating the step b) until a preset number of iterations is reached.

Attention Mechanism

The attention mechanism stems from the study of human vision. In cognitive science, due to the bottleneck of information processing, humans will selectively focus on the part of the information they want to see, while ignoring other visible information, this mechanism is called the attention mechanism. Nowadays, attention mechanism is widely used in the field of artificial intelligence, including image recognition, natural language processing, etc. In neural networks, the attention mechanism is the focus on the assignment of input weights. The attention mechanism can assign weights to the importance of elements, focusing on important information with high weights, and ignoring irrelevant information with low weights. In addition, it can continuously adjust the weights, so that important information can also be selected in different situations, so it has higher scalability and robustness. In the time series prediction problem, the attention mechanism can prevent important features from being ignored due to the increase of time step. The weight allocation method can be expressed by formulas (16) and (17), where hₜ, is the state vector of the hidden layer in the neural network at time t, eₜ is the attention probability distribution value, a₂, is the attention score, uₐ and Wₐ are the attention weight vectors, bₐ is the attention bias vector.

$$\begin{matrix}\begin{matrix}{a}_{t} = \frac{exp ( {e}_{t} )}{{\sum }_{k = 1}^{t} {e}_{k}} & ( 16 )\end{matrix} \\ \begin{matrix}{e}_{t} = {u}_{a} tanh ( {W}_{a} {h}_{t} + {b}_{a} ) & ( 17 )\end{matrix}\end{matrix}$$

Improved GRU Wave Energy Prediction Model

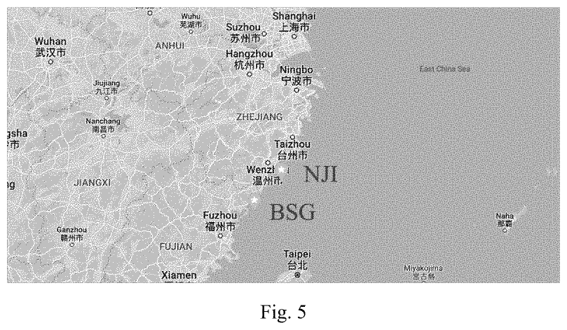

The structure of the GRU wave energy prediction model based on Bayesian optimization and attention mechanism is shown in FIG. 4. A method for predicting wave energy based on improved GRU comprises steps of:
1) determining input features of a prediction model;
2) using a Bayesian optimization algorithm to determine hyperparameters of the prediction model, wherein in a hidden layer of the prediction model, different weights are assigned to the input features through an attention mechanism; 3) training the prediction model to obtain wave height and wave period prediction models;
4) using a test set to compare prediction results of the prediction model with observed values, so as to determine whether an optimization end condition of the Bayesian optimization algorithm is reached; if yes, using the wave height and wave period prediction models to predict a wave height and a wave period separately; if not, continuing hyperparameter optimization; and
5) using a wave energy conversion formula to convert predicted values of the wave height and the wave period into a predicted value of wave energy.

In the training process of the model, the present invention selects the mean square error (MSE) as the loss function, as shown in formula (18), where n is the number of samples, yᵢ is the observed value, and xᵢ is the predicted value. The update of the weight parameters is done by the Adam optimizer. The Adam optimizer combines the advantages of RMSProp and AdaGrad algorithms that are good at dealing with sparse gradients and non-stationary objectives, and it can achieve good results at a fast speed. To prevent overfitting during model training, we adopted the Early Stopping algorithm, which stops training if the error on the validation set increases as the training rounds increase.

$$MSE = \frac{1}{n} {\sum }_{i = 1}^{n} {( {y}_{i} - {x}_{i} )}^{2} \qquad ( 18 )$$

Ocean Observation Data

The present invention selects the observation data of two observation stations in the coastal waters of China to achieve accurate prediction of wave energy. The data comes from Marine Professional Knowledge Service System (http://ocean.ckcest.cn/). The time interval of the observation data is 1 hour and the precision is 0.1. The selected dataset contains observations for all time frames of the year. Therefore, the predictive performance of the model under various different environmental conditions can be evaluated. The details of the two stations are shown in Table 1, and FIG. 5 shows their geographic distribution.

| | | | | Maximum | Maximum | |
|---|---|---|---|---|---|---|
| | | | | wind speed | wave | Data |
| Station | Latitude | longitude | Time | (m/s) | height (m) | size |
| NJI | 27.5N | 121.1E | 2018 Jul. 1- | 23.7 | 7.5 | 9504 |
| | | | 2019 Jul. 31 | | | |
| BSG | 26.7N | 120.3E | 2019 Aug. 1- | 21.6 | 4.5 | 9504 |
| | | | 2020 Aug. 31 | | | |

Data Preprocessing

Missing Value Padding

The observation station is not a perfect ocean monitoring system. Due to factors such as the design life of the equipment and the natural wear and tear of the instruments, observation interruption and missing data are common, so there are many missing values in the original observation data. In order to improve data quality and reduce the impact of missing values on model prediction accuracy, the present invention uses the before and after average value filling method to fill missing values in the data set, that is, the average value of the attribute value at the moment before the missing value and the attribute value at the moment after the missing value is taken as the filling value at the missing moment. The fill value is calculated as shown in Equation (19). When multiple consecutive values are missing, the average value of the two adjacent non-null values is used to fill in.

$$x = \frac{{x}_{- 1} + {x}_{1}}{2} \qquad ( 19 )$$

Feature Selection

Since ocean waves are waves of sea water caused by the action of wind, there is a close relationship between wind and ocean waves. Previous studies have also shown that wind speed and direction are important factors affecting ocean waves. Based on past research, in order to train a model with high prediction accuracy without consuming a lot of computing resources, the wind speed and wind direction data within 2 hours of history are selected as the characteristics of the prediction model. In addition, the wave height and wave period within 2 hours of history are also added. Therefore, the 8 features of the model are historical 1-hour wind speed, historical 1-hour wind direction, historical 1-hour wave height, historical 1-hour wave period, historical 2-hour wind speed, historical 2-hour wind direction, historical 2-hour wave height, historical 2-hour wave period.

Feature Normalization

In a model with multiple features, different units of measurement of features will lead to different calculation results. Large-scale features will play a decisive role, while small-scale features may be ignored. In order to eliminate the influence of measurement unit and scale differences between different features, the present invention adopts zero-mean normalization to process feature data. This method can speed up the speed of gradient descent to find the optimal solution. The standardized data has a mean of 0 and a standard deviation of 1, which follows a standard normal distribution. Its calculation formula is shown in (20), where n is the sample size, X″ is the processed data, X is the original data, X̅ is the mean of the original data, and δ is the standard deviation of the original data. The standard deviation is calculated as formula (21).

$${X}^{s} = \frac{X - \overline{X}}{δ} \qquad ( 20 )$$

$$δ = \sqrt{\frac{1}{n} {\sum }_{i = 1}^{n} {( {X}_{i} - \overline{X} )}^{2}} \qquad ( 21 )$$

Model Hyperparameters

In the present invention, the hyperparameters of the GRU wave energy prediction model and the hyperparameters of the other three comparison algorithms are optimized based on the Bayesian optimization algorithm, and the number of optimization iterations is 30. The value range and final value of the hyperparameters to be optimized are shown in Table 2 and Table 3, among them, time_step is the time step, units is the number of neurons, dense is the number of fully connected layer nodes, the number of n estimators trees, and max depth is the maximum depth of the tree. In addition, the learning rates of the neural networks GRU, LSTM, and MLP are all 0.001, and the training rounds are all 100. The activation function of GRU and LSTM is tan h, as shown in formula (4), and the activation function of MLP is linear rectification function (ReLU), as shown in formula (22).

ReLU(x)=max(0,x) (22)

| | | Optimi- | 1-hour | 1-hour | 6-hour | 6-hour |
|---|---|---|---|---|---|---|
| | Hyper- | zation | wave | wave | wave | wave |
| Algorithm | parameter | range | height | period | height | period |
| GRU | time_step | (2, 128) | 47 | 21 | 2 | 19 |
| | units | (2, 128) | 33 | 19 | 128 | 22 |
| | dense | (2, 128) | 37 | 6 | 100 | 57 |
| LSTM | time step | (2, 128) | 12 | 26 | 40 | 85 |
| | units | (2, 128) | 24 | 11 | 108 | 61 |
| | dense | (2, 128) | 7 | 3 | 82 | 89 |
| MLP | units | (2, 128) | 53 | 37 | 110 | 40 |
| RF | n estimators | (10, 200) | 64 | 181 | 137 | 31 |
| | max depth | (5, 10) | 6 | 5 | 5 | 8 |

| | | Optimi- | 1-hour | 1-hour | 6-hour | 6-hour |
|---|---|---|---|---|---|---|
| | Hyper- | zation | wave | wave | wave | wave |
| Algorithm | parameter | range | height | period | height | period |
| GRU | time_step | (2, 128) | 79 | 33 | 69 | 6 |
| | units | (2, 128) | 34 | 11 | 35 | 31 |
| | dense | (2, 128) | 127 | 16 | 127 | 38 |
| LSTM | time step | (2, 128) | 25 | 48 | 68 | 10 |
| | units | (2, 128) | 16 | 37 | 13 | 103 |
| | dense | (2, 128) | 86 | 12 | 34 | 73 |
| MLP | units | (2, 128) | 21 | 48 | 99 | 3 |
| RF | n estimators | (10, 200) | 53 | 13 | 34 | 31 |
| | max depth | (5, 10) | 6 | 7 | 8 | 5 |

Model Evaluation Index

In order to comprehensively evaluate the prediction accuracy of the model, the present invention selects MSE, root mean square error (RMSE), mean absolute error (M AE), mean absolute percentage error (MAPE), Pearson correlation coefficient (R) and coefficient of determination (R²) as the evaluation index of the model. Through these evaluation indicators, we can clearly see the performance of the prediction model in the test set, including the difference between the observed value and the predicted value, and the degree of correlation between the observed value and the predicted value. They are represented by formulas (18), (23), (24), (25), (26), (27), respectively, where n is the number of samples, yⁱ is the observed value, xⁱ is the predicted value, y̅ₜ is the mean of yₜ, and x̅ₜ is the mean of xᵢ.

$$RMSE = \sqrt{\frac{1}{n} {\sum }_{i = 1}^{n} {( {y}_{i} - {x}_{i} )}^{2}} \qquad ( 23 )$$

$$MAE = \frac{1}{n} {\sum }_{i = 1}^{n} \vert {y}_{i} - {x}_{i} \vert \qquad ( 24 )$$

$$MAPE = {\sum }_{i = 1}^{n} \vert \frac{{y}_{i} - {x}_{i}}{{y}_{i}} \vert \times \frac{100}{n} \qquad ( 25 )$$

$$R = \frac{{\sum }_{i = 1}^{n} ( {y}_{i} - {\overline{y}}_{i} ) ( {x}_{i} - {\overline{x}}_{i} )}{\sqrt{{\sum }_{i = 1}^{n} {( {y}_{i} - {\overline{y}}_{i} )}^{2} {\sum }_{i = 1}^{n} {( {x}_{i} - {\overline{x}}_{i} )}^{2}}} \qquad ( 26 )$$

$${R}^{2} = 1 - \frac{{\sum }_{i = 1}^{n} {( {y}_{i} - {x}_{i} )}^{2}}{{\sum }_{i = 1}^{n} {( {y}_{i} - {\overline{y}}_{i} )}^{2}} \qquad ( 27 )$$

The Prediction Results of the Model

1-Hour Prediction Result

Table 4 shows the 1-hour wave height prediction results of the wave height prediction model at the two stations after the training of the four algorithms is completed. The best results have been marked in bold. It can be seen from the results that because both LSTM and GRU are improved from RNN, they can effectively learn historical information. So, their prediction performance is better than MLP and RF. Among them, all the evaluation indicators based on the improved GRU proposed in the present invention are optimal at the two stations. The prediction accuracy of MLP is higher than that of RF. It can be seen that in the prediction of wave height, the prediction effect of neural network is better than that of traditional machine learning algorithm. Compared with the LSTM algorithm, in the wave height prediction of the NJI station, the MSE of the GRU based on Bayesian optimization and attention mechanism is reduced by about 8.3%, the R MSE is reduced by about 3.8%, the MAE is reduced by about 10.9%, the MAPE is reduced by about 12.4%, the R is improved by about 12.4%, and the R is improved by about 0.5%.

| | Algo- | | | | | | |
|---|---|---|---|---|---|---|---|
| Station | rithm | MSE | RMSE | MAE | MAPE | R | R² |
| NJI | GRU | 0.0100 | 0.1002 | 0.0667 | 0.0658 | 0.9695 | 0.9397 |
| | LSTM | 0.0109 | 0.1042 | 0.0749 | 0.0751 | 0.9676 | 0.9347 |
| | MLP | 0.0116 | 0.1078 | 0.0778 | 0.0802 | 0.9644 | 0.9301 |
| | RF | 0.0139 | 0.1180 | 0.0865 | 0.0868 | 0.9577 | 0.9163 |
| BSG | GRU | 0.0085 | 0.0925 | 0.0612 | 0.0824 | 0.9583 | 0.9179 |
| | LSTM | 0.0090 | 0.0949 | 0.0649 | 0.0905 | 0.9564 | 0.9135 |
| | MLP | 0.0099 | 0.0997 | 0.0692 | 0.0944 | 0.9536 | 0.9045 |
| | RF | 0.0101 | 0.1005 | 0.0725 | 0.1011 | 0.9506 | 0.9029 |

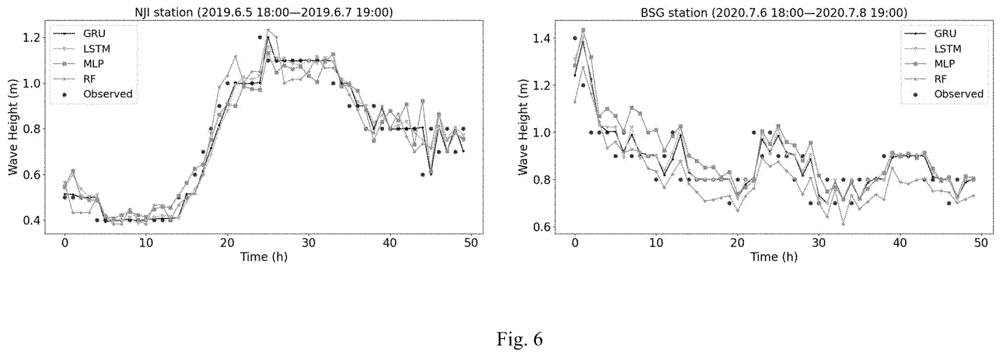

In order to observe the 1-hour wave height prediction effect of the model more vividly, we selected the observation data for a period of time at the two stations and compared the prediction data of the four algorithms, and obtained FIG. 6. In the figure, we can clearly see that the fitting effect of the GRU algorithm based on Bayesian optimization and attention mechanism is better than other algorithms. The performance of LSTM and GRU is similar, and the prediction effect is satisfactory. There are many fluctuations in the prediction curves of MLP and RF algorithms, especially for RF, the prediction effect is not as good as GRU and LSTM, which may be related to the simpler model structure.

Table 5 summarizes the 1-hour wave period prediction results of the four types of algorithms at two stations, and the best results have been marked in bold. Similar to wave height prediction, the evaluation indicators of the GRU algorithm based on Bayesian optimization and attention mechanism proposed in the present invention are the best, followed by LSTM and MLP, and RF is the worst. Compared with the LSTM algorithm, in the wave period prediction of the NJI station, the MSE of the GRU based on Bayesian optimization and attention mechanism is reduced by about 3.4%, the RMSE is reduced by about 1.8%, the MAE is reduced by about 0.6%, the MAPE is reduced by about 0.5%, the R is improved by about 0.2%, and the R² is improved by about 0.4%.

| | Algo- | | | | | | |
|---|---|---|---|---|---|---|---|
| Station | rithm | MSE | RMSE | MAE | MAPE | R | R² |
| NJI | GRU | 0.1457 | 0.3816 | 0.2422 | 0.0440 | 0.9484 | 0.8993 |
| | LSTM | 0.1508 | 0.3884 | 0.2436 | 0.0442 | 0.9465 | 0.8957 |
| | MLP | 0.1545 | 0.3931 | 0.2557 | 0.0466 | 0.9452 | 0.8932 |
| | RF | 0.1510 | 0.3886 | 0.2534 | 0.0463 | 0.9468 | 0.8956 |
| BSG | GRU | 0.1233 | 0.3512 | 0.2643 | 0.0504 | 0.9355 | 0.8737 |
| | LSTM | 0.1290 | 0.3591 | 0.2690 | 0.0509 | 0.9326 | 0.8679 |
| | MLP | 0.1405 | 0.3748 | 0.2825 | 0.0540 | 0.9276 | 0.8561 |
| | RF | 0.1442 | 0.3797 | 0.2820 | 0.0535 | 0.9256 | 0.8523 |

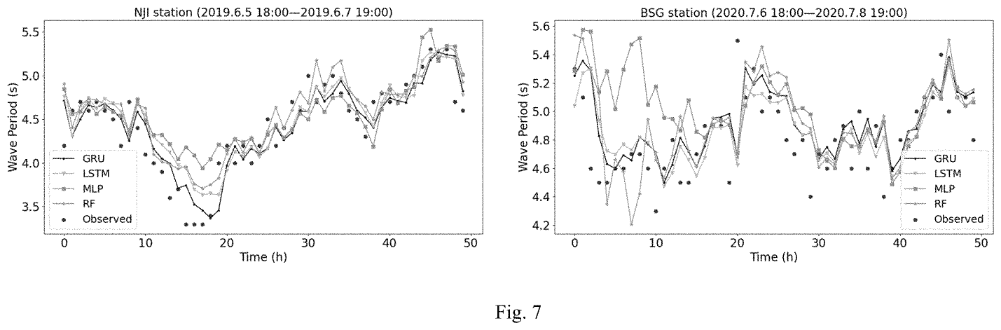

FIG. 7 shows the comparison curves of the predicted and observed values of the four algorithms. From the NJI station, we can see that when the wave period changes smoothly, the prediction gap between the four algorithms is not large; from the BSG station, when the wave cycle fluctuates frequently, the deviation between the prediction curve of MLP and RF and the observation curve is large. The prediction accuracy has dropped. Since GRU and LSTM can make decisions in the future according to the changing laws of historical time series information, they can better fit observations.

Table 6 shows the 1-hour wave energy prediction performance of the four algorithms under different evaluation indicators, and the optimal results have been marked in bold. From the comparison of algorithms, the four algorithms have shown satisfactory results in 1-hour wave energy prediction, and their R are all greater than 91%. The GRU based on Bayesian optimization and attention mechanism has the best performance in all evaluation metrics. In the NJI station, the MAE is 0.5555, and the R² is 91.27%. Compared with wave height and wave period prediction, the prediction results of LSTM and MLP are similar, and there is no obvious difference. The above results verify that the four algorithms GRU, LSTM, MLP, and RF all have high prediction accuracy in 1-hour wave energy prediction, and the improved GRU proposed in the present invention is superior in 1-hour wave energy prediction.

| | Algo- | | | | | | |
|---|---|---|---|---|---|---|---|
| Station | rithm | MSE | RMSE | MAE | MAPE | R | R² |
| NJI | GRU | 1.1170 | 1.0569 | 0.5555 | 0.1552 | 0.9554 | 0.9127 |
| | LSTM | 1.2459 | 1.1162 | 0.5882 | 0.1651 | 0.9522 | 0.9027 |
| | MLP | 1.1537 | 1.0741 | 0.5943 | 0.1794 | 0.9540 | 0.9099 |
| | RF | 1.5407 | 1.2412 | 0.6694 | 0.1920 | 0.9389 | 0.8796 |
| BSG | GRU | 1.3733 | 0.1719 | 0.3686 | 0.1876 | 0.9180 | 0.8422 |
| | LSTM | 1.4531 | 1.2055 | 0.3805 | 0.2001 | 0.9161 | 0.8330 |
| | MLP | 1.4534 | 1.2056 | 0.4143 | 0.2157 | 0.9177 | 0.8330 |
| | RF | 1.4579 | 1.2074 | 0.3973 | 0.2161 | 0.9166 | 0.8324 |

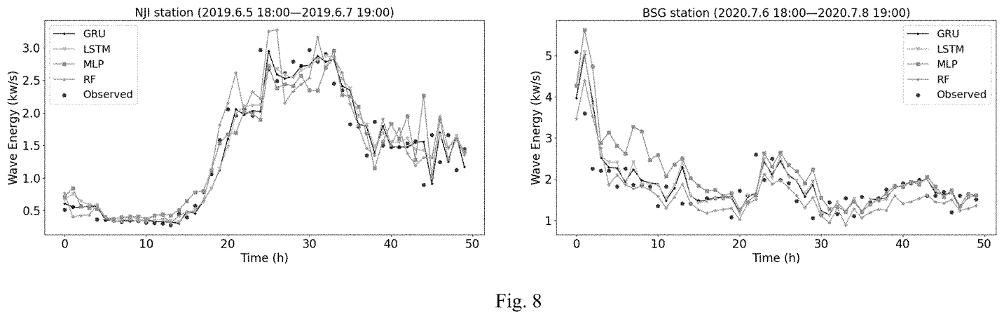

FIG. 8 shows the curve comparison of the predicted values and observed values of wave energy for the four algorithms in the 1-hour prediction. It can be seen from the figure that in the two stations, the prediction effect of each algorithm is similar to that of wave height prediction, and the prediction values of GRU and LSTM are closer to the observed values; the prediction values of MLP and RF are prone to fluctuations and large errors.

6-Hour Prediction Result

Table 7 summarizes the 6-hour wave height prediction results of the four algorithms at the two stations, and the best results have been marked in bold. It can be seen from the table that with the increase of the forecast time interval, the forecast accuracy of each algorithm decreases. Taking the GRU based on Bayesian optimization and attention mechanism proposed in the present invention as an example, at the NJI station, compared with the 1-hour wave height prediction, its MSE increased by about 409%, RMSE increased by about 125%, MAE increased is about 143%, MAPE is increased by about 144%, R is decreased by about 13.8%, and R² is decreased by about 26%. Even so, the performance of the GRU based on Bayesian optimization and attention mechanism proposed in the present invention is still the best in all evaluation metrics. The prediction accuracy of LSTM is similar to that of GRU.

| | Algo- | | | | | | |
|---|---|---|---|---|---|---|---|
| Station | rithm | MSE | RMSE | MAE | MAPE | R | R² |
| NJI | GRU | 0.0509 | 0.2255 | 0.1619 | 0.1604 | 0.8354 | 0.6957 |
| | LSTM | 0.0516 | 0.2271 | 0.1680 | 0.1732 | 0.8323 | 0.6915 |
| | MLP | 0.0522 | 0.2284 | 0.1668 | 0.1681 | 0.8298 | 0.6879 |
| | RF | 0.0557 | 0.2361 | 0.1731 | 0.1723 | 0.8264 | 0.6667 |
| BSG | GRU | 0.0392 | 0.1980 | 0.1383 | 0.1880 | 0.8107 | 0.6274 |
| | LSTM | 0.0414 | 0.2035 | 0.1463 | 0.2176 | 0.7956 | 0.6067 |
| | MLP | 0.0474 | 0.2178 | 0.1644 | 0.2520 | 0.7772 | 0.5492 |
| | RF | 0.0463 | 0.2151 | 0.1605 | 0.2450 | 0.7823 | 0.5603 |

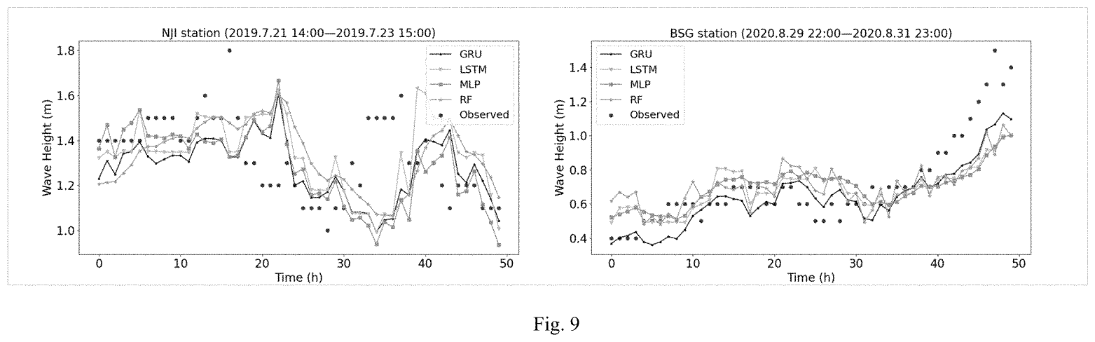

FIG. 9 shows the curve comparison of the predicted values of wave heights and the observed values of the four algorithms in the 6-hour prediction. It can be seen from the figure that compared with the 1-hour prediction, the predicted value curve of each algorithm has a relatively obvious deviation compared with the observed value curve, and the deviation shows a slight hysteresis. When the wave height fluctuates, the forecast deviation is more serious. From the comparison of different algorithms, it can be seen that the observed value curve of GRU is closer to the observed value, which is especially obvious at the BSG station.

Table 8 summarizes the 6-hour wave period prediction results of the four algorithms at the two stations, and the best results have been marked in bold. It can be seen from the table that, as with the 6-hour wave height prediction, with the increase of the forecast time interval, the forecasting accuracy of each algorithm decreases, but the forecasting accuracy is still within the acceptable range. The performance of the GRU based on Bayesian optimization and attention mechanism proposed in the present invention is still the best in all evaluation indicators. Compared with the 1-hour wave period prediction, at the NJI station, the MSE of the GRU increased by about 240%, the RMSE increased by about 84.5%, the MAE increased by about 115%, the MAPE increased by about 111.6%, the R decreased by about 13.9%, and the R² decreased by about 27.1%.

| | Algo- | | | | | | |
|---|---|---|---|---|---|---|---|
| Station | rithm | MSE | RMSE | MAE | MAPE | R | R² |
| NJI | GRU | 0.4958 | 0.7041 | 0.5218 | 0.0931 | 0.8170 | 0.6556 |
| | LSTM | 0.5039 | 0.7099 | 0.5243 | 0.0960 | 0.8163 | 0.6499 |
| | MLP | 0.5028 | 0.7091 | 0.5260 | 0.0951 | 0.8183 | 0.6507 |
| | RF | 0.5679 | 0.7536 | 0.5544 | 0.1000 | 0.7910 | 0.6055 |
| BSG | GRU | 0.4411 | 0.6642 | 0.5011 | 0.0957 | 0.7511 | 0.5554 |
| | LSTM | 0.4774 | 0.6910 | 0.5145 | 0.0963 | 0.7359 | 0.5188 |
| | MLP | 0.4597 | 0.6780 | 0.5164 | 0.0999 | 0.7441 | 0.5367 |
| | RF | 0.5122 | 0.7157 | 0.5505 | 0.1063 | 0.7141 | 0.4838 |

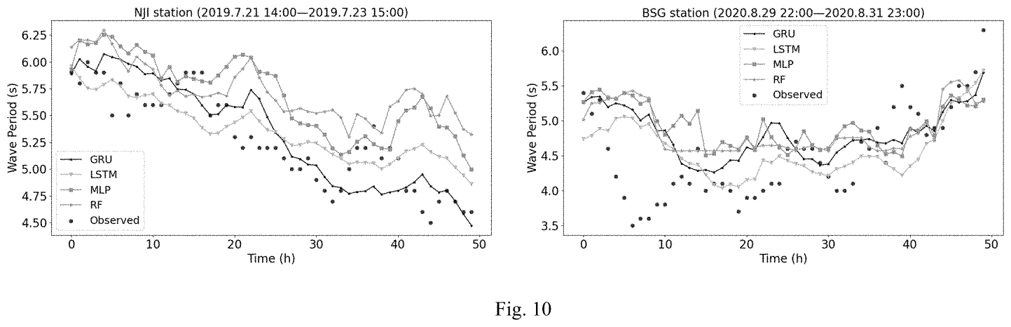

FIG. 10 shows the comparison of the predicted and observed curves for the 6-hour wave period for the four algorithms. Compared with FIG. 7, the prediction deviation of each algorithm increases, and the RF algorithm is the most serious. In the curve graph of the NJI station, although the observed value of the wave period has been decreasing, the numerical fluctuation is small, and the deviation between the predicted curve and the observed value curve of each algorithm is also small, especially GRU, the fitting effect is better. In the curve graph of the BSG station, the observed value of the wave period fluctuates frequently up and down. In this case, the deviation between the predicted curve of each algorithm and the observed value curve is also larger. Therefore, the prediction accuracy of the model under numerical fluctuation still needs to be improved.

Through the wave height, period and power conversion formula, Table 9 summarizes the 6-hour wave energy prediction results of the four algorithms at two stations, and the optimal result has been marked in bold. As can be seen from the table, compared with Table 6, the accuracy of each algorithm has decreased. Because the GRU based on Bayesian optimization and attention mechanism proposed in the present invention is the best in the prediction of 6-hour wave height and period, its prediction accuracy is still the highest in wave energy prediction.

| | Algo- | | | | | | |
|---|---|---|---|---|---|---|---|
| Station | rithm | MSE | RMSE | MAE | MAPE | R | R² |
| NJI | GRU | 4.6245 | 2.1505 | 1.2011 | 0.3561 | 0.8045 | 0.6436 |
| | LSTM | 4.6835 | 2.1641 | 1.2490 | 0.4088 | 0.7997 | 0.6390 |
| | MLP | 4.8384 | 2.1996 | 1.2631 | 0.3891 | 0.7932 | 0.6271 |
| | RF | 5.4742 | 2.3397 | 1.3616 | 0.4093 | 0.7722 | 0.5781 |
| BSG | GRU | 5.7110 | 2.3898 | 0.8204 | 0.4272 | 0.6653 | 0.3549 |
| | LSTM | 8.1342 | 2.8520 | 0.8533 | 0.5028 | 0.5600 | 0.0812 |
| | MLP | 6.1702 | 2.4840 | 0.9070 | 0.6285 | 0.6471 | 0.3031 |
| | RF | 6.7340 | 2.5950 | 0.9249 | 0.6176 | 0.6112 | 0.2394 |

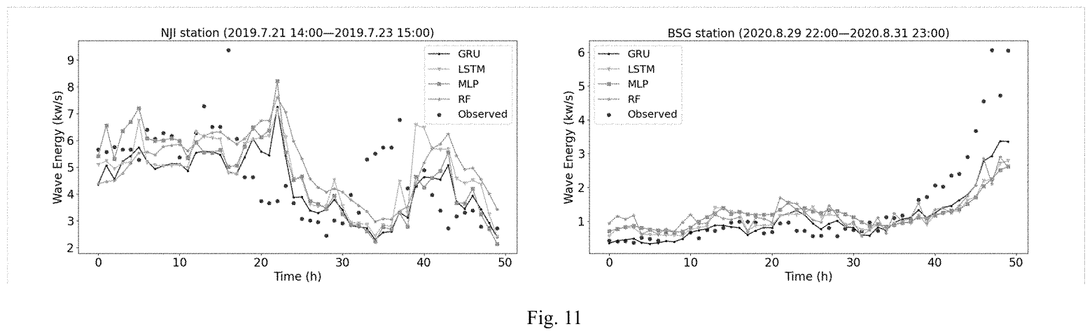

FIG. 11 shows the comparison between the 6-hour wave energy prediction values of the four algorithms and the observed values. From the NJI station, due to numerical fluctuations, the predicted values of each algorithm have obvious deviations compared with the observed values. At the BSG station, since the wave energy changes relatively smoothly, the prediction effect of each algorithm is better. In summary, in the case of stable numerical fluctuations, the prediction accuracy of the algorithm is higher.

With the rapid development of the economy and the continuous growth of energy demand, the greenhouse gases produced by the combustion of fossil energy have caused more and more pressure on the environment. In recent years, many countries have proposed target plans to achieve carbon neutrality. The development of renewable energy can reduce the dependence on fossil energy and promote the realization of carbon neutrality. As one of the most important energy sources in ocean energy, wave energy can replace fossil energy and reduce pollutant emissions through effective development and utilization. In order to promote the development and utilization of wave energy, the present invention proposes a wave energy prediction model based on improved GRU. Past research has shown that GRU simplifies the neural network structure on the basis of LSTM and improves the learning efficiency of the model because the gate with small contribution and its corresponding weight are removed. Based on the original GRU, the model adds a Bayesian optimization algorithm to optimize the hyperparameters of the model. In addition, an attention mechanism is added to assign different weights to the features in the model training process to achieve a more accurate prediction effect. With the help of the conversion formula between wave elements and wave energy, we use this model to predict the wave height and wave period, and indirectly achieve accurate prediction of wave energy. The present invention selects data from two Chinese stations to train and test the model. Compared with the three mainstream algorithms of LSTM, MLP and RF, the GRU based on Bayesian optimization and attention mechanism proposed in the present invention has the highest accuracy in the prediction of wave height, wave period and wave energy in 1-hour and 6-hour. In the 1-hour and 6-hour wave energy predictions of the two stations, the minimum MAE are 0.3686 and 0.8204, respectively, and the maximum R² are 0.9127 and 0.6436, respectively. To sum up, the GRU based on Bayesian optimization and attention mechanism proposed in the present invention can achieve accurate 1-hour and 6-hour wave energy power prediction, which will provide a reference for the location selection of wave energy power generation devices, and help the application and promotion of wave energy.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for predicting wave energy based on improved gated recurrent unit (GRU), comprising steps of:
1) determining input features of a prediction model;
2) using a Bayesian optimization algorithm to determine hyperparameters of the prediction model, wherein in a hidden layer of the prediction model, different weights are assigned to the input features through an attention mechanism;
3) training the prediction model to obtain wave height and wave period prediction models;
4) using a test set to compare prediction results of the prediction model with observed values, so as to determine whether an optimization end condition of the Bayesian optimization algorithm is reached; if yes, using the wave height and wave period prediction models to predict a wave height and a wave period separately; if not, continuing hyperparameter optimization;
5) using a wave energy conversion formula to convert predicted values of the wave height and the wave period into a predicted value of wave energy; and
6) providing a reference for location selection of wave energy power generation devices, so as to improve application and promotion of wave energy.

2. The method, as recited in claim 1, wherein in the step 1), the input features are: historical 1-hour wind speed, historical 1-hour wind direction, historical 1-hour wave height, historical 1-hour wave period, historical 2-hour wind speed, historical 2-hour wind direction, historical 2-hour wave height, and historical 2-hour wave period.

3. The method, as recited in claim 1, wherein in the step 1), the input features are normalized with following formulas:
$$\begin{matrix}{X}^{s} = \frac{X - \overline{X}}{δ} \\ δ = \sqrt{\frac{1}{n} {\sum }_{i = 1}^{n} {( {X}_{i} - \overline{X} )}^{2}}\end{matrix}$$
wherein n is a sample size, X^{δ} is a processed data, X is an original data, X̅ is a mean of the original data, and δ is a standard deviation of the original data.

4. The method, as recited in claim 2, wherein in the step 1), the input features are normalized with following formulas:
$$\begin{matrix}{X}^{s} = \frac{X - \overline{X}}{δ} \\ δ = \sqrt{\frac{1}{n} {\sum }_{i = 1}^{n} {( {X}_{i} - \overline{X} )}^{2}}\end{matrix}$$
wherein n is a sample size, X^{δ} is a processed data, X is an original data, X̅ is a mean of the original data, and S is a standard deviation of the original data.

5. The method, as recited in claim 1, wherein in the step 2), a method for determine the hyperparameters of the prediction model comprises steps of:
a) randomly initializing a set of hyperparameter value combinations in a search space, and calculating a value of an objective optimization function; wherein for the search space Xₙ, an optimal solution x_{best} of Bayesian optimization is expressed by a formula:
x_{best}=argmin_{Xn}ƒ(xₙ)
wherein ƒ is the objective optimization function;
b) continuing to randomly select a hyperparameter combination, calculating an objective function value, and saving a point if the objective function value thereof is better than a best value obtained in history; and
c) repeating the step b) until a preset number of iterations is reached.

6. The method, as recited in claim 1, wherein in the step 2), a Gaussian process of Bayesian optimization consists of following mean and covariance functions:
ƒ(x)˜gp(μ,k(x,x¹))
wherein μ is the mean function and k(x, x¹) is the covariance function; for a dataset D={(x₁,ƒ(X₁)), (x₂, ƒ(X₂)), . . . , (xₜ,ƒ(xₜ))}, a Gaussian distribution is expressed as:
$$[ \begin{matrix}f ( {x}_{1} ) \\ f ( {x}_{2} ) \\ ⋮ \\ f ( {x}_{t} )\end{matrix} ] ∼ ℊ p ( μ , [ \begin{matrix}k ( {x}_{1} , {x}_{1} ) & k ( {x}_{1} , {x}_{2} ) & … & k ( {x}_{1} , {x}_{t} ) \\ k ( {x}_{2} , {x}_{1} ) & k ( {x}_{2} , {x}_{2} ) & … & k ( {x}_{2} , {x}_{t} ) \\ ⋮ & ⋮ & ⋮ & ⋮ \\ k ( {x}_{t} , {x}_{1} ) & k ( {x}_{t} , {x}_{2} ) & … & k ( {x}_{t} , {x}_{t} )\end{matrix} ] )$$
for the new sample [symbol] , the Gaussian distribution is expressed as:
$$\begin{matrix}[ \begin{matrix}{f}_{1 : t} \\ {f}_{t + 1}\end{matrix} ] ∼ ℊ p ( μ , [ \begin{matrix}K & {k}^{T} \\ k & k ( {x}_{t + 1} , {x}_{t + 1} )\end{matrix} ] ) \\ \begin{matrix}wherein & K = [ \begin{matrix}k ( {x}_{1} , {x}_{1} ) & … & k ( {x}_{1} , {x}_{t} ) \\ ⋮ & ⋱ & ⋮ \\ k ( {x}_{t} , {x}_{1} ) & … & k ( {x}_{t} , {x}_{t} )\end{matrix} ] , & and\end{matrix} \\ k = [ ( ( {x}_{t + 1} , {x}_{1} ) , ( {x}_{t + 1} , {x}_{2} ) … ( {x}_{t + 1} , {x}_{t} ) ) ] ;\end{matrix}$$
a posterior probability distribution of [symbol] is expressed as:
P( [symbol] |D, [symbol] )=gp(u( [symbol] ),δ²( [symbol] ))
wherein u( [symbol] )=kK⁻¹ƒ₁₋ₜ, and δ²( [symbol] )=k( [symbol] )−kK⁻¹ k^{T}.

7. The method, as recited in claim 5, wherein in the step 2), a Gaussian process of Bayesian optimization consists of following mean and covariance functions:
ƒ(x)˜gp(μ,k(x,x′))
wherein μ is the mean function and k(x, x′) is the covariance function; for a dataset D=[(x₁,ƒ(X₁)), (x₂, ƒ(X₂)), . . . , (xₜ,ƒ(xₜ))], a Gaussian distribution is expressed as:
$$[ \begin{matrix}f ( {x}_{1} ) \\ f ( {x}_{2} ) \\ ⋮ \\ f ( {x}_{t} )\end{matrix} ] ∼ ℊ p ( μ , [ \begin{matrix}k ( {x}_{1} , {x}_{1} ) & k ( {x}_{1} , {x}_{2} ) & … & k ( {x}_{1} , {x}_{t} ) \\ k ( {x}_{2} , {x}_{1} ) & k ( {x}_{2} , {x}_{2} ) & … & k ( {x}_{2} , {x}_{t} ) \\ ⋮ & ⋮ & ⋮ & ⋮ \\ k ( {x}_{t} , {x}_{1} ) & k ( {x}_{t} , {x}_{2} ) & … & k ( {x}_{t} , {x}_{t} )\end{matrix} ] )$$
for the new sample [symbol] , the Gaussian distribution is expressed as:
$$\begin{matrix}[ \begin{matrix}{f}_{1 : t} \\ {f}_{t + 1}\end{matrix} ] ∼ ℊ p ( μ , [ \begin{matrix}K & {k}^{T} \\ k & k ( {x}_{t + 1} , {x}_{t + 1} )\end{matrix} ] ) \\ \begin{matrix}wherein & K = [ \begin{matrix}k ( {x}_{1} , {x}_{1} ) & … & k ( {x}_{1} , {x}_{t} ) \\ ⋮ & ⋱ & ⋮ \\ k ( {x}_{t} , {x}_{1} ) & … & k ( {x}_{t} , {x}_{t} )\end{matrix} ] , & and\end{matrix} \\ k = [ ( ( {x}_{t + 1} , {x}_{1} ) , ( {x}_{t + 1} , {x}_{2} ) … ( {x}_{t + 1} , {x}_{t} ) ) ] ;\end{matrix}$$
a posterior probability distribution of [symbol] is expressed as:
P( [symbol] |D, [symbol] )=gp(u( [symbol] ),δ²( [symbol] ))
wherein u( [symbol] )=kK⁻¹ƒ₁₋ₜ, and δ²( [symbol] )=k( [symbol] )−kK⁻¹ k^{T}.

8. The method, as recited in claim 1, wherein in the step 2), the different weights are assigned to the input features according to following formulas:
$$\begin{matrix}{a}_{t} = \frac{exp ( {e}_{t} )}{{\sum }_{k = 1}^{t} {e}_{k}} \\ {e}_{t} = {u}_{a} tanh ( {W}_{a} {h}_{t} + {b}_{a} )\end{matrix}$$
wherein hₜ is a state vector of the hidden layer in a neural network at a time t, eₜ is an attention probability distribution value, aₜ is an attention score, uₐ and Wₐ are attention weight vectors, bₐ is an attention bias vector.

9. The method, as recited in claim 7, wherein in the step 2), the different weights are assigned to the input features according to following formulas:
$$\begin{matrix}{a}_{t} = \frac{exp ( {e}_{t} )}{{\sum }_{k = 1}^{t} {e}_{k}} \\ {e}_{t} = {u}_{a} tanh ( {W}_{a} {h}_{t} + {b}_{a} )\end{matrix}$$
wherein hₜ is a state vector of the hidden layer in a neural network at a time t, eₜ is an attention probability distribution value, aₜ is an attention score, uₐ and Wₐ are attention weight vectors, bₐ is an attention bias vector.

10. The method, as recited in claim 1, wherein in the step 3), a mean square error is used as a loss function:
$$MSE = \frac{1}{n} {\sum }_{i = 1}^{n} {( {y}_{i} - {x}_{i} )}^{2}$$
wherein n is a number of samples, yᵢ is the observed value, and xᵢ is the predicted value.

11. The method, as recited in claim 1, wherein in the step 4), a time interval of the observed values is 1 hour and a precision is 0.1; the observed values are obtained by observations for all time frames of the year.

12. The method, as recited in claim 1, wherein in the step 4), to improve data quality and reduce an impact of missing values on model prediction accuracy, a before and after average value filling method is used to fill missing values in the test set, wherein an average value of an attribute value at a moment before the missing value and an attribute value at a moment after the missing value is taken as a filling value at a missing moment; when multiple consecutive values are missing, an average value of two adjacent non-null values is used to fill in.

13. The method, as recited in claim 11, wherein in the step 4), to improve data quality and reduce an impact of missing values on model prediction accuracy, a before and after average value filling method is used to fill missing values in the test set, wherein an average value of an attribute value at a moment before the missing value and an attribute value at a moment after the missing value is taken as a filling value at a missing moment; when multiple consecutive values are missing, an average value of two adjacent non-null values is used to fill in.
